(19) United States
(12) Patent Application Publication
(10) Pub. No.: US 2025/0170774 A1
(43) Pub. Date: May 29, 2025

(54) 3D PRINTER HAVING POWDER SCATTERING PREVENTION FUNCTION

(71) Applicant: KLABS INC., Ulsan (KR)

(72) Inventors: Won Hyo KIM, Ulsan (KR); Hyun Seok SEO, Ulsan (KR)

(21) Appl. No.: 18/755,345

(22) Filed: Jun. 26, 2024

(30) Foreign Application Priority Data
Nov. 23, 2023 (KR) 10-2023-0164282

(51) Int. Cl. B29C 64/25; B22F 12/00; B22F 12/70; B29C 64/30; B33Y 30/00; B33Y 40/00

(52) U.S. Cl. CPC B29C 64/25; B22F 12/38; B22F 12/70; B29C 64/30; B33Y 30/00; B33Y 40/00

(57) ABSTRACT

A 3D printer has a powder scattering prevention function for forming an object layer by layer using powder. The 3D printer is capable of improving the quality of an object by preventing undesired scattering of powder. The 3D printer may include a build box provided therein with a build plate; a supply box provided therein with a supply plate configured to supply powder to the build box; a binder nozzle disposed above the build box and configured to spray a binder into the build box; and a fine water nozzle disposed on a side of the binder nozzle, disposed above the build box and configured to atomize water into fine water particles using ultrasonic waves and spraying the fine water particles into the build box.

### CROSS REFERENCE TO RELATED APPLICATION

The present application claims priority to Korean Patent Application No. 10-2023-0164282, filed Nov. 23, 2023, the entire contents of which are incorporated herein for all purposes by this reference.

### BACKGROUND OF THE INVENTION

### Field of the Invention

The present disclosure relates to a 3D printer having a powder scattering prevention function.

### Description of the Related Art

Three-dimensional (3D) printing technology refers to a manufacturing technology that creates an object by printing it in a 3D space on the basis of 3D drawings.

In the early days of development, 3D printing technology was used only for extremely limited purposes due to the high price of 3D printers. However, recently, 3D printing technology has become popular as the price of 3D printers has become cheaper, and materials have expanded to nylon, metal, etc. without being limited to plastic, so its application is expanding to almost all industrial fields.

3D printing methods include a stereo-lithographic apparatus (SLA) method that uses a laser beam to selectively solidify photocurable resin, a selective laser sintering (SLS) method that uses a laser beam to selectively sinter functional polymer powder or metal powder instead of photocurable resin used in the SLA method, a laminated object manufacturing (LOM) method that involves cutting cross-sections having desired shapes out of sheets of adhesive-coated paper using a laser beam and stacking them together to form an object layer by layer, and a binder jet method that involves applying powder to a build plate and spraying a binder (adhesive) onto a desired area of the powder applied to the build plate to bond the powder together to form an object layer by layer.

In this regard, a 3D printer with a powder scattering prevention function that creates an object using a binder and powder is described in Korean Patent No. 10-1872210 (hereinafter referred to as “Patent Document 1”).

In Patent Document 1, as a head is moved along the X and Y axes orthogonal to each other over an object box, the head sprays a binder onto a part of a layer of powder in an internal space of the object box to bond the powder together, thereby building up an object layer by layer.

Patent Document 1 is, however, problematic in that droplets of the binder sprayed from the head may cause powder ejection or fine powder may be scattered by a surrounding flow. As described above, when the powder is scattered, it may be scattered on the build plate and be re-deposited on the powder already bonded, or it may block a spray port of the head and interfere with the spraying of the binder.

This undesired scattering of the powder may affect the quality of the object, and the powder blocking the spray port of the head may cause damage to the head.

The foregoing is intended merely to aid in the understanding of the background of the present disclosure, and is not intended to mean that the present disclosure falls within the purview of the related art that is already known to those skilled in the art.

### DOCUMENTS OF RELATED ART

(Patent Document 1) Korean Patent No. 10-1872210

### SUMMARY OF THE INVENTION

Accordingly, the present disclosure has been made keeping in mind the above problems occurring in the related art, and an objective of the present disclosure is to provide a 3D printer having a powder scattering prevention function, the 3D printer being capable of improving the quality of an object by preventing undesired scattering of powder.

In order to achieve the above objective, according to one aspect of the present disclosure, there is provided a 3D printer having a powder scattering prevention function, the 3D printer including: a build box provided therein with a build plate; a supply box provided therein with a supply plate configured to supply powder to the build box; a binder nozzle disposed above the build box and configured to spray a binder into the build box; and a fine water nozzle disposed on a side of the binder nozzle, disposed above the build box and configured to atomize water into fine water particles using ultrasonic waves and spraying the fine water particles into the build box.

According to another aspect of the present disclosure, there is provided a 3D printer having a powder scattering prevention function, the 3D printer including: a build box provided therein with a build plate; a binder nozzle disposed above the build box and configured to spray a binder onto a layer of powder formed in the build box; a chamber in which the build box and the binder nozzle are disposed; a blowing fan provided above the chamber to be located above the binder nozzle and configured to generate a descending airflow; a fine water spray device configured to atomize water into fine water particles using ultrasonic waves and spray the fine water particles so that the fine water particles flow to an upper part of the build box together with the descending airflow; and an exhaust part provided below the chamber to be located below the build box and configured to exhaust the descending airflow to an outside of the chamber.

According to another aspect of the present disclosure, there is provided a 3D printer having a powder scattering prevention function, the 3D printer including: a build box provided therein with a build plate; a binder nozzle disposed above the build box and configured to spray a binder onto a layer of powder formed in the build box; a chamber in which the build box and the binder nozzle are disposed; a blowing fan provided above the chamber to be located above the binder nozzle and configured to generate a descending airflow; a fine water spray device configured to atomize water into fine water particles using ultrasonic waves and spray the fine water particles so that the fine water particles flow to an upper part of the build box together with the descending airflow; and a return part configured to return the descending airflow to the blowing fan.

According to another aspect of the present disclosure, there is provided a 3D printer having a powder scattering prevention function for forming an object layer by layer using powder, the 3D printer including: a chamber forming an internal space; a blowing fan provided above the chamber and configured to generate a descending airflow; and a fine water spray device configured to atomize water into fine water particles using ultrasonic waves and spray the fine water particles so that the fine water particles flow together with the descending airflow.

The 3D printer having the powder scattering prevention function according to the present disclosure has the following effects.

By reducing the mobility of the powder by making it wet through the fine water nozzle, it is possible to prevent undesired scattering of the powder.

By preventing scattering of the powder, it is possible to improve the quality of an object and prevent damage to the binder nozzle.

By enabling fine water sprayed from the fine water spray device to flow inside the chamber together with the descending airflow, it is possible to control the humidity inside the chamber, thereby preventing scattering of the powder.

By filtering out the powder in the exhaust part through the exhaust part filter, it is possible to prevent the powder from flowing out of the chamber through the exhaust part.

By controlling the humidity by ultrasonically spraying the fine water, it is possible to control the humidity without increasing the temperature inside the chamber. Therefore, it is possible to prevent the powder from scattering due to an ascending airflow caused by an increase in the temperature inside the chamber.

By circulating the descending airflow and fine water inside the chamber through the return part, it is possible to easily achieve humidity control inside the chamber without a separate exhaust part.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a 3D printer having a powder scattering prevention function according to a first embodiment of the present disclosure; and

FIG. 2 is a view illustrating a 3D printer having a powder scattering prevention function according to a second embodiment of the present disclosure.

### DETAILED DESCRIPTION OF THE INVENTION

Contents of the description below merely exemplify the principle of the present disclosure. Therefore, those of ordinary skill in the art may implement the theory of the present disclosure and invent various apparatuses which are included within the concept and the scope of the present disclosure even though it is not clearly explained or illustrated in the description. Furthermore, in principle, all the conditional terms and embodiments listed in this description are clearly intended for the purpose of understanding the concept of the present disclosure, and one should understand that the present disclosure is not limited to the exemplary embodiments and the conditions.

The above described objectives, features, and advantages will be more apparent through the following detailed description related to the accompanying drawings, and thus those of ordinary skill in the art may easily implement the technical spirit of the present disclosure.

The embodiments of the present disclosure are described with reference to cross-sectional views and/or perspective views which schematically illustrate ideal embodiments of the present disclosure. The technical terms used herein is for the purpose of describing particular embodiments only and is not intended to be limiting. The singular forms “a”, “an”, and “the” are intended to include the plural forms as well, unless the context clearly indicates otherwise. It will be further understood that the terms “comprise”, “include”, “have”, etc., when used in this specification, specify the presence of stated features, integers, steps, operations, elements, components, and/or combinations thereof but do not preclude the presence or addition of one or more other features, integers, steps, operations, elements, components, and/or combinations thereof.

Reference will now be made in greater detail to exemplary embodiments of the present disclosure, examples of which are illustrated in the accompanying drawings. In describing various embodiments below, the same reference numerals will be used throughout different embodiments and the description to refer to the same or like elements or parts. In addition, the configuration and operation already described in other embodiments will be omitted for convenience.

### 3D Printer 10 Having Powder Scattering Prevention Function According to First Embodiment of the Present Disclosure

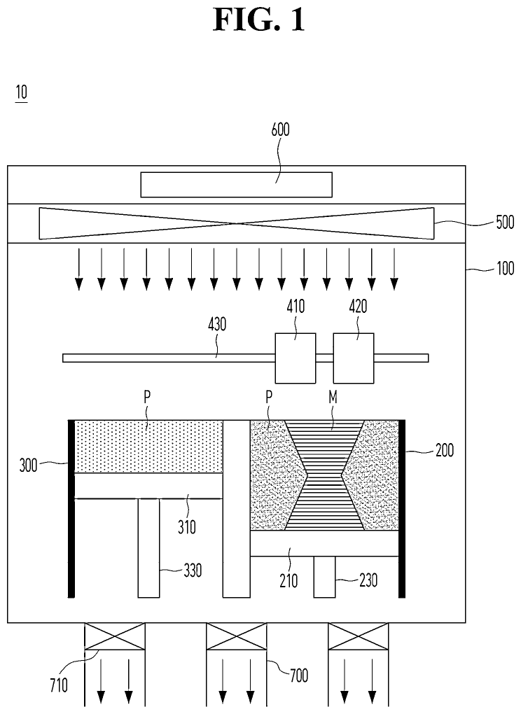

Hereinafter, a 3D printer 10 having powder scattering prevention function according to a first embodiment of the present disclosure will be described with reference to FIG. 1.

FIG. 1 is a view illustrating the 3D printer 10 having the powder scattering prevention function according to the first embodiment of the present disclosure.

As illustrated in FIG. 1, the 3D printer 10 having the powder scattering prevention function according to the first embodiment of the present disclosure includes a build box 200 provided therein with a build plate 210, a supply box 300 provided therein with a supply plate 310 supplying powder P to the build box 200, a build plate lifting means 230 lifting and lowering the build plate 210, a supply plate lifting means 330 lifting and lowering the supply plate 310, a binder nozzle 410 disposed above the build box 200 and spraying a binder into the build box 200, a fine water nozzle 420 disposed on a side of the binder nozzle 410, disposed above the build box 200, and atomizing water into fine water particles using ultrasonic waves and spraying the fine water particles into the build box 200, a chamber 100 in which the build box 200, the supply box 300, the binder nozzle 410, and the fine water nozzle 420 are disposed, a blowing fan 500 provided above the chamber 100 to be located above the binder nozzle 410 and the fine water nozzle 420 and generating a descending airflow, a fine water spray device 600 atomizing water into fine water particles using ultrasonic waves and spraying the fine water particles so that the fine water particles (fine water) flow to an upper part of the build box 200 together with the descending airflow, an exhaust part 700 provided below the chamber 100 to be located below the build box 200 and exhausting the descending airflow to the outside of the chamber 100, and an exhaust part filter 710 provided in the exhaust part 700 and filtering out the powder P.

The build box 200 is a space where an object M is formed, and the build plate 210 is provided inside the build box 200.

The build box 200 has open upper and lower surfaces and closed front, rear, left, and right surfaces.

The build plate 210 provided inside the build box 200 replaces the open lower surface of the build box 200 and closes the lower surface of the build box 200.

The build plate 210 is lifted and lowered in an internal space of the build box 200 by the build plate lifting means 230. The supply box 300 is a space where the powder P is stored, and the supply plate 310 is provided inside the supply box 300.

The supply box 300 has open upper and lower surfaces and closed front, rear, left, and right surfaces.

The supply plate 310 provided inside the supply box 300 replaces the open lower surface of the supply box 300 and closes the lower surface of the supply box 300.

The supply plate 310 is lifted and lowered in an internal space of the supply box 300 by the supply plate lifting means 330.

The powder P is stored on an upper part of the supply plate 310, and the supply plate 310 is lifted by the supply plate lifting means 330. A powder flattening means (not illustrated) pushes the powder P toward the build box 200, thereby supplying the powder P into the build box 200. In this case, the powder P supplied into the build box 200 is stacked to form a plurality of layers of the powder P.

The binder nozzle 410 is installed on a rail 430 disposed above the build box 200 and the supply box 300. The rail 430 is provided above the build box 200 and the supply box 300 to have a longitudinal direction in each of the X-axis and Y-axis directions.

The binder nozzle 410 is moved in the X and Y axes along the rail 430 above the build box 200 and the supply box 300, and is lifted and lowered in the vertical direction (i.e., moved in the Z axis).

The binder nozzle 410 sprays the binder on a part of a layer of the powder P supplied to the build box 200 to bond the powder P together. In this case, the binder nozzle 410 sprays the binder on the part of the layer of the powder P in a shape output from a controller (not illustrated) and bonds the powder P in a desired shape to form a layer of the powder P, and a plurality of layers of the powder P are stacked to form the shape of the object M.

The stacking of the layers of the powder P is achieved by repeating the process of lowering the build plate 210 by a predetermined distance by the build plate lifting means 230 and lifting the supply plate 310 by the supply plate lifting means 330 to supply the powder P into the build box 200.

That is, the powder P is supplied into the build box 200 as the supply plate 310 is lifted while the build plate 210 is lowered, and the supplied powder P is bonded together by the binder sprayed from the binder nozzle 410, so the layers of the powder P are stacked one by one while forming a shape.

The fine water nozzle 420 is installed on the rail 430 disposed above the build box 200 and the supply box 300.

The fine water nozzle 420 is moved in the X and Y axes along the rail 430 above the build box 200 and the supply box 300, and is lifted and lowered in the vertical direction (i.e., moved in the Z axis).

As described above, as the fine water nozzle 420 is installed on the rail 430 together with the binder nozzle 410, the fine water nozzle 420 may be disposed on the side of the binder nozzle 410.

The fine water nozzle 420 may include a first ultrasonic generator (not illustrated) and a first tank (not illustrated).

Ultrasonic waves generated by the first ultrasonic generator vibrate water stored in the first tank and atomizes the water into fine water particles. The fine water nozzle 420 sprays the fine water particles atomized by ultrasonic waves in the direction of the build box 200.

The first tank may be supplied with water by communicating with a separate first water supply part (not illustrated). Unlike the fine water nozzle 420, the first water supply part may be located in a position other than above the build box 200 and the supply box 300. Therefore, the first tank can be reduced in size, thereby ensuring free movement of the fine water nozzle 420.

The fine water sprayed from the fine water nozzle 420 is sprayed into the build box 200, causing the powder P inside the build box 200 to become wet. Therefore, the mobility of the powder P can be reduced, thereby preventing undesired scattering of the powder P.

The chamber 100 surrounds the build box 200, the supply box 300, the binder nozzle 410, and the fine water nozzle 420, so the build box 200, the supply box 300, the binder nozzle 410, and the fine water nozzle 420 are disposed in an internal space of the chamber 100.

The chamber 100 functions to isolate the build box 200, the supply box 300, the binder nozzle 410, and the fine water nozzle 420 from the external environment. Therefore, the chamber 100 can prevent the powder P from scattering to the outside of the chamber 100.

The blowing fan 500 is disposed above the chamber 100 and is located above the binder nozzle 410 and the fine water nozzle 420.

The blowing fan 500 generates a descending airflow by rotation.

The fine water spray device 600 is disposed above or below the blowing fan 500 and atomizes water into fine water particles using ultrasonic waves and sprays the fine water particles. The fine water spray device 600 may include a second ultrasonic generator (not illustrated) and a second tank (not illustrated).

Ultrasonic waves generated by the second ultrasonic generator vibrate water stored in the first tank and atomizes the water into fine water particles. The fine water spray device 600 sprays the fine water particles atomized by ultrasonic waves in the direction of the descending airflow.

The exhaust part 700 is disposed below the chamber 100 and is located below the build box 200.

The exhaust part 700 functions to exhaust the descending airflow inside the chamber 100 to the outside of the chamber 100.

As described above, as the blowing fan 500 is disposed above the chamber 100 and the exhaust part 700 is disposed below the chamber 100, the descending airflow generated by the blowing fan 500 can easily flow downward toward a lower part of the chamber 100.

The exhaust part 700 may be connected to an exhaust line connected to an external intake device and exhaust the airflow in the chamber 100 using suction force.

The fine water particles (fine water) sprayed from the fine water spray device 600 flow together with the descending airflow.

As the fine water particles (fine water) sprayed from the fine water spray device 600 flow together with the descending flow from the upper part to the lower part of the chamber 100, the humidity inside the chamber 100 is increased.

As the humidity inside the chamber 100 is increased, the powder P becomes wet and the mobility thereof is reduced. Therefore, undesired scattering of the powder P can be prevented.

The exhaust part filter 710 is provided in the exhaust part 700 and functions to filter out the powder P. Therefore, when the descending airflow entrains the powder P therein, the exhaust part filter 710 filters out the powder P to prevent the powder P from flowing out of the chamber 100 through the exhaust part 700.

According to the 3D printer 10 having the powder scattering prevention function according to the first embodiment of the present disclosure, by controlling the wet state of the powder P through fine water particles (fine water) sprayed from the fine water nozzle 420 and the fine water spray device 600, it is possible to prevent scattering of the powder P. As described above, as the fine water particles prevent the powder P from scattering, it is possible to increase the quality of an object and prevent damage to the binder nozzle 410. That is, scattering of the powder P is prevented by making the powder P wet through moisture.

In addition, by controlling the humidity inside the chamber 100 by ultrasonically spraying the fine water particles through the fine water nozzle 420 and the fine water spray device 600, it is possible to control the humidity without a change in heat inside the chamber 100.

In detail, when the humidity is controlled by boiling water using a heating fine water spray device, the temperature inside the chamber 100 is increased by a heater device that applies heat to the water.

Due to the above temperature increase, an ascending airflow is generated inside the chamber 100. This ascending airflow causes the powder P to scatter upward, further promoting scattering of the powder P. As a result, a problem occurs in that the quality of an object deteriorates due to scattering of the powder P.

However, in the case of the present disclosure, as the fine water nozzle 420 and the fine water spray device 600 ultrasonically atomize water into fine water particles (fine water) and spray the fine water particles, it is possible to prevent the powder P from scattering upward due to the descending airflow while controlling the humidity without changing the temperature inside the chamber 100.

It is preferable that the water used in the fine water nozzle 420 and the fine water spray device 600 described above is distilled water. This is because distilled water does not contain foreign substances, so it is possible to prevent foreign substances from sticking to an object and deteriorating the quality of the object.

### 3D Printer 10′ Having Powder Scattering Prevention Function According to Second Embodiment of the Present Disclosure

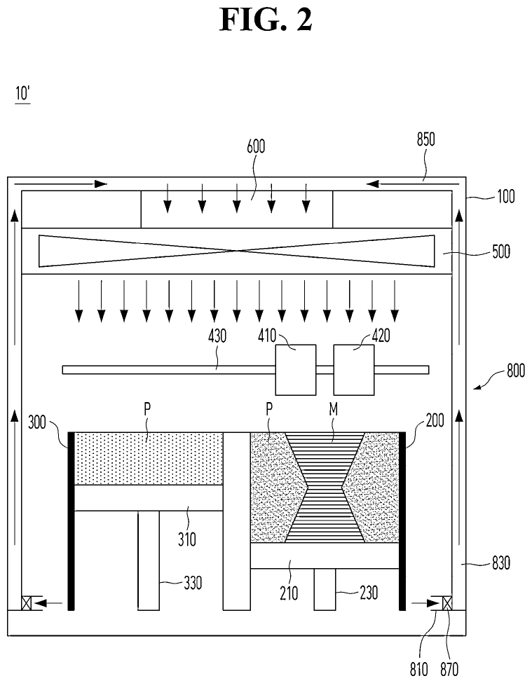

Hereinafter, a 3D printer 10′ having powder scattering prevention function according to a second embodiment of the present disclosure will be described with reference to FIG. 2.

FIG. 2 is a view illustrating the 3D printer 10′ having the powder scattering prevention function according to the second embodiment of the present disclosure.

As illustrated in FIG. 2, the 3D printer 10′ having the powder scattering prevention function according to the first embodiment of the present disclosure includes a build box 200 provided therein with a build plate 210, a supply box 300 provided therein with a supply plate 310 supplying powder P to the build box 200, a build plate lifting means 230 lifting and lowering the build plate 210, a supply plate lifting means 330 lifting and lowering the supply plate 310, a binder nozzle 410 disposed above the build box 200 and spraying a binder into the build box 200, a fine water nozzle 420 disposed on a side of the binder nozzle 410, disposed above the build box 200, and atomizing water into fine water particles using ultrasonic waves and spraying the fine water particles into the build box 200, a chamber 100 in which the build box 200, the supply box 300, the binder nozzle 410, and the fine water nozzle 420 are disposed, a blowing fan 500 provided above the chamber 100 to be located above the binder nozzle 410 and the fine water nozzle 420 and generating a descending airflow, a fine water spray device 600 atomizing water into fine water particles using ultrasonic waves and spraying the fine water particles so that the fine water particles (fine water) flow to an upper part of the build box 200 together with the descending airflow, a return part 800 returning the descending airflow to the blowing fan 500, and a return part filter 870 provided in the return part 800 and filtering out the powder P.

The 3D printer 10′ having the powder scattering prevention function according to the second embodiment of the present disclosure remains the same as the 3D printer 10 having the powder scattering prevention function according to the first embodiment of the present disclosure described above, except that the return part 800 and the return part filter 870 are provided instead of the exhaust part 700 and the exhaust part filter 710. Therefore, description of the same configurations is omitted.

The return part 800 functions to return the descending airflow generated by the blowing fan 500 to the blowing fan 500.

The return part 800 may include a return part inlet 810 disposed in a lower part of the chamber 100, a communication space 850 in communication with the blowing fan 500, and a return path 830 communicating the return part inlet 810 and the communication space 850 with each other.

The return part inlet 810 is a part where the descending airflow flowing to the lower part of the chamber 100 is introduced.

The return part inlet 810 is formed to have a longitudinal direction horizontally in the left and right or front and rear directions toward the inside of the chamber 100 in the lower part of the chamber 100.

The return path 830 has a lower part in communication with the return part inlet 810.

The return path 830 is formed to extend in the vertical direction.

The communication space 850 communicates with an upper part of the return path 830, and the return part filter 870 and the blowing fan 500 are disposed in a lower part of the communication space 850.

The communication space 850, the return part filter 870, and the blowing fan 500 are all connected vertically.

The return part filter 870 is provided in the return part 800 and functions to filter out the powder P. Therefore, when the descending airflow entrains the powder P therein, the return part filter 870 filters out the powder P to prevent the powder P from flowing back to the blowing fan 500 through the return part 800 and being circulated inside the chamber 100.

The return part filter 870 is preferably disposed at the return part inlet 810. This is to prevent the powder P from sticking to the return path 830.

The return part 800 may be provided with a separate return part fan (not illustrated).

The return part fan provides suction force to the return part 800 so that the airflow flows into the return part 800 through the return part inlet 810 and then flows upward through the return path 830.

Of course, even when the return part fan is not provided, the airflow may be introduced into the return part 800 and circulated through the suction force of the blowing fan 500.

A plurality of return parts 800 may be provided. As an example, as illustrated in FIG. 2, two return parts 800 may be provided on opposite sides of the chamber 100, respectively.

The descending airflow flowing to the lower part of the chamber 100 flows upward along the return path 830 through the return part inlet 810, then it flows into the communication space 850 and flows to the blowing fan 500 through the return part filter 870.

The descending airflow flowing through the blowing fan 500 flows back to the lower part of the chamber 100 by the blowing fan 500. Therefore, the airflow inside the chamber 100 is continuously circulated by the return part 800.

The fine water sprayed from the fine water spray device 600 is circulated inside the chamber 100 by the blowing fan 500 and the return part 800 together with the descending airflow. Therefore, the environment inside the chamber 100 is replaced with a humid environment, and the humidity inside the chamber 100 is controlled. That is, the humidity inside the chamber 100 may be controlled depending on whether the fine water spray device 600 is operated.

As described above, according to the 3D printer 10′ having the powder scattering prevention function according to the second embodiment of the present disclosure, by continuously circulating the descending airflow and moisture, which are generated through the blowing fan 500 and the fine water spray device 600 inside the chamber 100, through the return part 800, it is possible to easily achieve humidity control inside the chamber 100.

Therefore, it is also possible to easily achieve control of the wet state of the powder P. This helps control the mobility of the powder P, thereby preventing undesired scattering of the powder P.

In addition, according to the 3D printer 10′ having the powder scattering prevention function according to the second embodiment of the present disclosure, by circulating the airflow inside the chamber 100 through the return part 800, it is possible to easily form the descending airflow inside the chamber 100 without a separate exhaust part. Therefore, it is possible to easily install and operate the 3D printer 10′ having the powder scattering prevention function even in places where there is no external exhaust line.

The 3D printers 10 and 10′ having the powder scattering prevention function according to the first and second embodiments of the present disclosure described above has been described as being applied to a binder jet method that forms an object M by bonding powder P together with a binder and stacking a plurality of layers of the powder P.

A 3D printer having a powder scattering prevention function may be applied not only to the binder jet method but also to a method of forming an object by bonding and sintering powder.

For example, a selective laser sintering (SLS) type 3D printer that uses a laser beam to sinter functional polymer powder or metal powder may also be provided with a fine water spray device 600 to wet the powder and prevent the powder from scattering.

An SLS type 3D printer having a powder scattering prevention function uses powder to form an object layer by layer, and may include a chamber forming an internal space, a blowing fan provided above the chamber and generate a descending airflow, a fine water spray device atomizing water into fine water particles using ultrasonic waves and spraying the fine water particles so that the fine water particles flow together with the descending airflow, and an exhaust part exhausting the descending airflow to the outside of the chamber. In the SLS type 3D printer having the powder scattering prevention function, the fine water particles entrained in the descending airflow inside the chamber are sprayed onto the powder to wet the powder, thereby effectively preventing the powder from scattering.

In addition, the SLS type 3D printer having the powder scattering prevention function may be provided with a return part that circulates the descending airflow and the fine water particles.

Although preferred embodiments of the present disclosure have been disclosed for illustrative purposes, those skilled in the art will appreciate that various modifications, additions, and substitutions are possible, without departing from the scope and spirit of the present disclosure. It is thus well known to those skilled in that art that the patent right of the present disclosure should be defined by the scope and spirit of the present disclosure as disclosed in the accompanying claims.

What is claimed is:

1. A 3D printer having a powder scattering prevention function, the 3D printer comprising:
a build box provided therein with a build plate;
a supply box provided therein with a supply plate configured to supply powder to the build box;
a binder nozzle disposed above the build box and configured to spray a binder into the build box; and
a fine water nozzle disposed on a side of the binder nozzle, disposed above the build box and configured to atomize water into fine water particles using ultrasonic waves and spraying the fine water particles into the build box.

2. A 3D printer having a powder scattering prevention function, the 3D printer comprising:
a build box provided therein with a build plate;
a binder nozzle disposed above the build box and configured to spray a binder onto a layer of powder formed in the build box;
a chamber in which the build box and the binder nozzle are disposed;
a blowing fan provided above the chamber to be located above the binder nozzle and configured to generate a descending airflow;
a fine water spray device configured to atomize water into fine water particles using ultrasonic waves and spray the fine water particles so that the fine water particles flow to an upper part of the build box together with the descending airflow; and
an exhaust part provided below the chamber to be located below the build box and configured to exhaust the descending airflow to an outside of the chamber.

3. A 3D printer having a powder scattering prevention function, the 3D printer comprising:
a build box provided therein with a build plate;
a binder nozzle disposed above the build box and configured to spray a binder onto a layer of powder formed in the build box;
a chamber in which the build box and the binder nozzle are disposed;
a blowing fan provided above the chamber to be located above the binder nozzle and configured to generate a descending airflow;
a fine water spray device configured to atomize water into fine water particles using ultrasonic waves and spray the fine water particles so that the fine water particles flow to an upper part of the build box together with the descending airflow; and
a return part configured to return the descending airflow to the blowing fan.

4. A 3D printer having a powder scattering prevention function for forming an object layer by layer using powder, the 3D printer comprising:
a chamber forming an internal space;
a blowing fan provided above the chamber and configured to generate a descending airflow; and
a fine water spray device configured to atomize water into fine water particles using ultrasonic waves and spray the fine water particles so that the fine water particles flow together with the descending airflow.
